(19) United States
(12) Patent Application Publication
(10) Pub. No.: US 2019/0122312 A1
(43) Pub. Date: Apr. 25, 2019

(54) DSRC ENABLED PRE-NEGOTIATED FUEL PURCHASE ACCOUNT LOCATION

(71) Applicant: Ford Global Technologies, LLC, Dearborn, MI (US)

(72) Inventors: Cynthia M. NEUBECKER, Westland, MI (US); Jayanthi RAO, West Bloomfield, MI (US); Anthony Gerald KING, Ann Arbor, MI (US); James Andrew MILOSER, Saline, MI (US)

(21) Appl. No.: 16/080,991

(22) PCT Filed: Mar. 1, 2016
(86) PCT No.: PCT/US2016/020200

§ 371 Date: Aug. 29, 2018

(51) Int. Cl. G06Q 50/06; G06Q 20/28; G06Q 20/32; G06Q 20/18; G06Q 20/20

(52) U.S. Cl. CPC G06Q 50/06; G06Q 20/28; G06Q 20/202; G06Q 20/18; G06Q 20/327

(57) ABSTRACT

A system for a vehicle includes a controller programmed to, in response to receiving from a business a confirmation generated responsive to a forwarded verification request that an account associated with the vehicle is supported by a pre-negotiated fuel purchase program in which the business participates, display a location of the business and in response to a disaffirmation generated responsive to the request, prevent the displaying.

### TECHNICAL FIELD

The present disclosure relates to systems and methods for receiving a notification via a dedicated short-range communications (DSRC) network connection indicative of a pre-negotiated fuel purchase account location.

### BACKGROUND

A vehicle may be configured to establish a wireless network connection using a variety of network types. In one example, the vehicle may be configured to accept a DSRC service broadcast using a DSRC network connection. A DSRC network uses one-way or two-way short- to medium-range wireless communication channels specifically designed for automotive use and a corresponding set of protocols and standards. The DSRC and its wireless component, wireless access in vehicular environments (WAVE) protocol, operate within the allocated 75-megahertz (MHz)-bandwidth of the 5.9 gigahertz (GHz) frequency spectrum band. The allocated bandwidth is divided into one control channel (CCH) and four to six service channels (SCHs).

### SUMMARY

A system for a vehicle includes a controller programmed to, in response to receiving from a business a confirmation generated responsive to a forwarded verification request that an account associated with the vehicle is supported by a pre-negotiated fuel purchase program in which the business participates, display a location of the business and in response to a disaffirmation generated responsive to the request, prevent the displaying.

A method for a vehicle includes, in response to receiving by a controller via a dedicated short range network a broadcast indicative of a business being a fuel purchase program participant and a confirmation generated responsive to a forwarded verification request that an account associated with the vehicle is supported by the program, displaying a location of the business, and in response to receiving a disaffirmation generated responsive to the forwarded verification request, preventing the displaying.

A pre-purchased fuel program participation system for a business includes a controller programmed to, in response to a confirmation generated by a server responsive to a verification request received from a vehicle and forwarded to the server, the confirmation indicative of an account associated with the vehicle being supported by a pre-purchased fuel program of which the business is a previously-acknowledged participant, transmit a location of the business to be displayed in the vehicle, and in response to a disaffirmation generated responsive to the verification request, prevent the transmitting of the location.

### BRIEF DESCRIPTION OF THE DRAWINGS

FIG. 1 is a block diagram illustrating a vehicle configured to receive a notification indicative of a pre-negotiated fuel purchase program support;

FIG. 2 is a block diagram illustrating a vehicle communication controller configured to receive, via a DSRC broadcast, a notification indicative of a pre-negotiated fuel purchase program support;

FIG. 3 is a block diagram illustrating an interface layout for setting up a pre-negotiated fuel purchase account;

FIG. 4 is a block diagram illustrating an interface layout for creating a group comprising a pre-negotiated fuel purchase account;

FIG. 5 is a block diagram illustrating an interface layout for joining an existing group comprising a pre-negotiated fuel purchase account;

FIG. 6 is a flowchart illustrating an algorithm for receiving a notification indicative of a pre-negotiated fuel purchase program support; and

FIG. 7 is a flowchart illustrating an algorithm for confirming a pre-negotiated fuel purchase program account.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

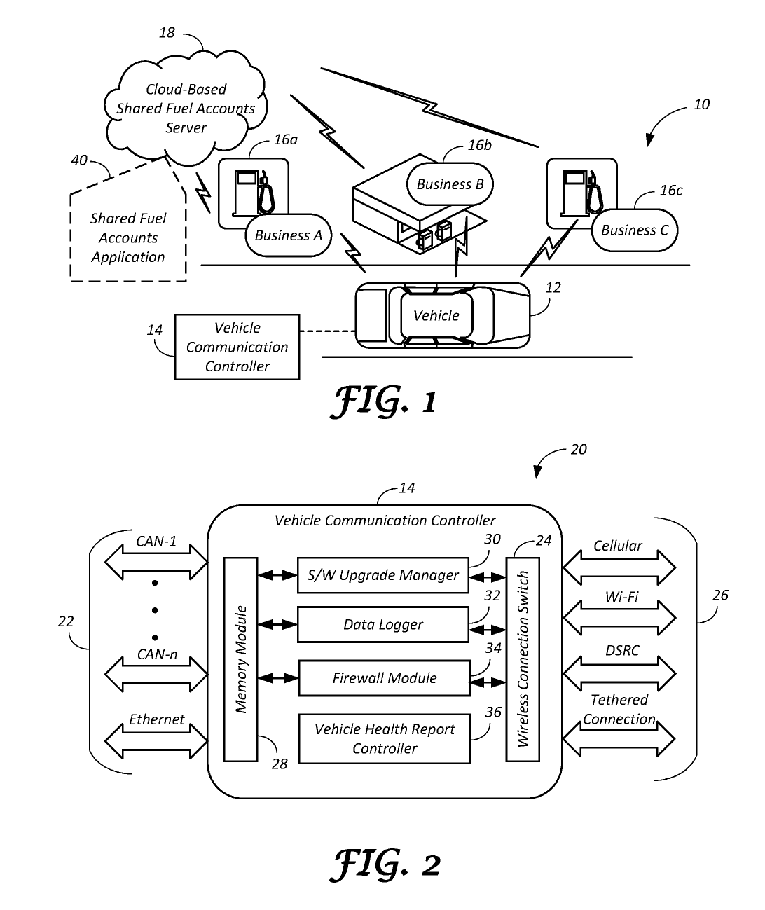

In reference to FIG. 1, a vehicle-to-infrastructure (V2I) communication system 10 is shown. The V2I communication system 10 uses a DSRC network connection to enable communication between a vehicle 12 and a business 16. In one example, the business 16 may be representative of a business, a commercial entity, an enterprise, or another type of organization broadcasting pre-negotiated fuel purchase program participation. The business 16 and the vehicle 12 may each include an antenna (not shown) configured to transmit and receive broadcasts via a DSRC network connection. The business 16 is in communication with a shared fuel accounts server 18 configured to receive a signal indicative of a request to confirm that a pre-negotiated fuel purchase account is a participating account. As will be described in further detail in reference to at least FIGS. 3-5, the shared fuel accounts server 18 includes a shared fuel accounts application 40 configured to receive input indicative of a shared fuel account setup and associate the input with a program account number.

The business 16 is configured to transmit, such as via a connection to a network infrastructure unit, to the vehicle 12 a DSRC broadcast indicative of pre-negotiated fuel purchase program participation. The business 16 may be further configured to receive a notification indicative of a request to confirm that a pre-negotiated fuel purchase program account. The business 16 may be configured to confirm that a pre-negotiated fuel purchase account is a participating account. The business 16 is configured to transmit a confirmation in response to the received pre-negotiated fuel purchase account being a participating account. The business 16 is configured to transmit a rejection in response to the received pre-negotiated fuel purchase account not being a participating account.

The DSRC network uses one-way or two-way short- to medium-range wireless communication channels specifically designed for automotive use and a corresponding set of protocols and standards. The DSRC and its wireless component, wireless access in vehicular environments (WAVE) protocol, operate within the allocated 75-megahertz (MHz)-bandwidth of the 5.9 gigahertz (GHz) frequency spectrum band. The allocated bandwidth is divided into one control channel (CCH) used to broadcast safety messages and announce available services and four to six service channels (SCHs) used for subsequent communication between the broadcasted service provider and a service user.

Messages between the business 16 and the vehicle 12 may be delivered using at least two communication protocols—the Internet Protocol version 6 (IPv6) and WAVE short messages protocol (WSMP). The DSRC protocol's use of IPv6 is unique in that it does not rely on MAC or IP address to make a connection with a vehicle within its signal range. Instead, the DSRC connection enables the business 16 to broadcast at least one DSRC service identified by a unique provider service identifier (PSID) without first establishing a connection with the vehicle 12.

The vehicle 12 may include a vehicle communication controller 14 (hereinafter controller 14) configured to receive from the business 16 a notification indicative of pre-paid fuel purchase program participation and transmit to the business 16 a request to confirm that a pre-negotiated fuel purchase program account associated with the vehicle 12 is a participating account. The controller 14 may be configured to display a location of the business 16 in response to a confirmation that the pre-negotiated fuel purchase program account is a participating account.

In reference to FIG. 2, an example configuration 20 of the controller 14 configured to receive a DSRC broadcast is shown. The controller 14 is configured to communicate with a vehicle data bus 22 (e.g., a CAN bus) that provides access to various other vehicle controllers, such as, but not limited to, an engine controller, a navigation controller comprising a Global Positioning System (GPS) receiver, and so on. In one example, the controller 14 may be integrated within a smart data link connector or within a telematics system of the vehicle 12, such as, for example, the SYNC® system offered by Ford Motor Company.

The controller 14 includes a wireless switch 24 configured to transmit and receive digital data using a variety of wireless networks 26 including, but not limited to, wireless personal area networks (WPANs), wireless local area networks (WLANs), wireless mesh networks, wireless metropolitan area networks (WMANs), wireless wide area networks (WWANs), cellular networks, global area networks (GAN), DSRC networks, networks using tethered connections, and so on. In one example, the wireless connection switch 24 may prioritize available wireless networks 26 based on one or more factors, such as, but not limited to, a data type associated with a transfer request, wireless link quality metrics, and so on, determined according to a set of prioritization policies. The controller 14 may transmit and receive digital data using any number of communication protocols, such as GSM (2G), ITU IMT-2000 (3G), IMT-Advanced (4G), IEEE 802.11a/b/g/n (Wi-Fi), WiMax, ANT™, ZigBee®, Bluetooth®, Near Field Communications (NFC), and others. In one example, the controller 14 may be further configured to communicate with a mobile device, such as, but not limited to, a mobile phone, a tablet, a laptop, a portable media player, and so on.

The controller 14 further comprises a memory module 28 including a non-persistent storage, e.g., random access memory (RAM), and persistent storage, a hard disk drive (HDD) or flash memory, a software upgrade manager 30 configured to detect and install available software updates via the vehicle data bus 22, a data logger 32 configured to capture and record data flow of the controller 14, and a firewall module 34 configured to monitor and filter network traffic to prevent a malicious intrusion. In one example, the controller 14 includes an ID and threat reporting module (not shown) configured to prevent threats and damage using encryption, e.g., WPA/WEP keys, and other security methods. The controller 14 also includes a vehicle health report (VHR) controller 36 configured to detect vehicle diagnostic conditions, determine their severity, and generate a vehicle health report for an owner of the vehicle 12.

The controller 14 may comprise (or be in communication with) a visual front end interface (shown generally as controller 14), such as a built-in vehicle navigation display. In one example, the visual front end interface may be configured to accept a user input via, for example, a touch sensitive screen. In another example, the visual front end interface may be configured to accept input through, among other means, button presses, gestures, audible speech, and speech synthesis. The visual front end interface of the vehicle 12 is configured to accept input indicative of a pre-negotiated fuel purchase account. The visual front end interface is configured to display location of the business 16 in response to a signal indicative of a pre-negotiated fuel purchase account associated with the vehicle 12 being a participating account.

In reference to FIG. 3, an account setup system 38 for purchasing fuel at a pre-negotiated price is shown. The shared fuel accounts application 40 is configured to receive input indicative of a pre-negotiated fuel purchase account setup. The application 40 may be hosted by the shared fuel accounts server 18 and may be configured to receive user input via a personal communication device, such as, but not limited to, personal computer, tablet, mobile phone, personal digital assistant, laptop, portable media player, wearable computer, and so on.

In one example, the application 40 is configured to receive input, e.g., via one or more input fields (dialog boxes or digital record frames) 42, indicative of purchasing a predetermined amount of fuel for a predetermined period. In another example, the application 40 may receive input indicative of purchasing a predetermined amount of fuel at a fixed price. The input fields 42 may include one or more selections associated with a pre-negotiated fuel purchase account, such as, but not limited to, fuel price, fuel amount, time period, fuel type, fuel grade, geographic area, vehicle identification information, user identification, payment method, and so on. The fuel price may be a daily average fuel price, an agreed-upon price, and so on. The fuel amount may be a predetermined number of gallons, liters, and so on. The time period may be a predetermined period, such as, but not limited to, a predetermined number of seconds, minutes, hours, days, weeks, months, years, and so on.

The fuel type may include, but is not limited to, one or more of gasoline, ethanol, natural gas, hydrogen, electricity, and so on. The fuel grade may include, but is not limited to, fuel meeting one or more fuel quality metrics, specifications, or characteristics, such as, but not limited to, a predetermined octane level. Geographic area associated with the pre-negotiated fuel purchase account may be an area extending a predetermined distance from a predetermined fixed or varying point. Vehicle identification information of the vehicle 12 may include, but is not limited to, a vehicle identification number (VIN), an identification number associated with a wireless transmitter located in (or used to start) the vehicle 12, and so on.

The user identification may include, but is not limited to, at least one of a personal identification document, a biometric identification parameter, a digital identification parameter, an embedded identification device, and so on. The payment method may, for example, include, but is not limited to, electronic payments using a credit card, debit card, check, money transfers, recurring cash or automated clearing house (ACH) disbursements, mobile payments and other forms of exchanging and/or provisioning payment methods.

Making a selection, entering an amount, and/or entering a time period using the input fields 42 may cause one or more computation fields 44 to display resulting estimates associated with a pre-negotiated fuel purchase account, such as, but not limited to, per unit cost, total cost, federal tax, state tax, fee(s), duty, tariff, custom, and so on. The application 40 may be configured to dynamically adjust the output of the one or more computation fields 44 based on fuel amount and/or time period entered using the input fields 42. In one example, the application 40 may be configured to provide a lower per unit cost in response to receiving a larger fuel amount and a shorter time period. In another example, the application 40 may be configured to provide a different per unit cost in response to receiving a different geographic location for a fuel purchase. While FIG. 3 describes fuel amount and time period as the input fields 42 and the per unit cost and total cost as the computation fields 44, other configurations, arrangements, layouts, and combinations of input and computation fields, including the input fields 42 for a per unit cost and/or total price, are also contemplated.

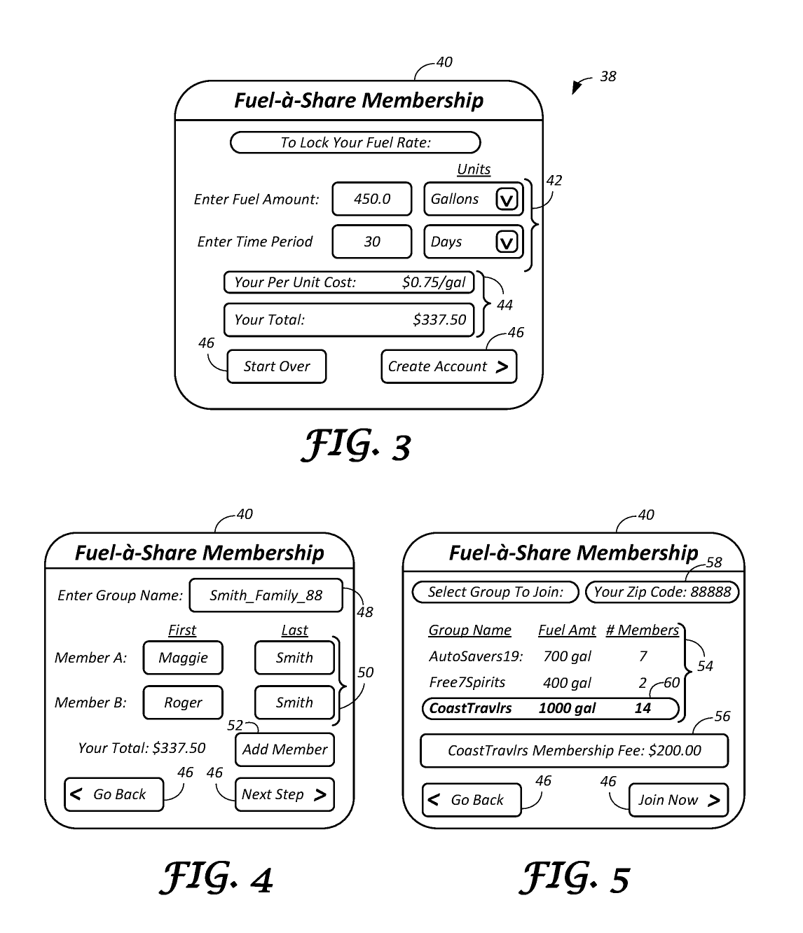

The application 40 may further include one or more action controls 46 indicative of operations associated with a pre-negotiated fuel purchase account, such as, but not limited to, next step, previous step, return, go back, create an account, reset, start over, chat with an assistant, ask a question, contact us, and so on. The application 40 may be configured to receive input indicative of one or more members associated with a pre-negotiated fuel purchase account. As shown in FIG. 4, the application 40 may include one or more group name fields 48, member name fields 50, and/or member controls 52. The one or more members of the group may include one or more users associated with a pre-negotiated fuel purchase account, such as, for example, an owner of the vehicle 12, family member(s) of the owner, friend(s), and so on. The member controls 52 may be indicative of member operations associated with a pre-negotiated fuel purchase account, such as, but not limited to, add member, edit member, remove member, and so on.

The member controls 52 may further include operations of one or more administrative users associated with a pre-negotiated fuel purchase account. The administrative user may be capable of restricting account actions made available to one or more other members of the account. In one example, the administrative user may restrict geographic area in which the one or more other members may acquire fuel using the account. In another example, the administrative user may set a maximum amount of fuel or cost per transaction the one or more other members may authorize using the account.

In reference to FIG. 5, the application 40 configured to receive input indicative of acquiring a membership with an existing pre-negotiated fuel purchase group 54 is shown. In one example, the group 54 may be a group of users sharing a predetermined amount of fuel purchased at a fixed price. In another example, the group 54 may share a predetermined amount of fuel at a fixed price for a predetermined period. In some embodiments, the group 54 may be a virtual group of users, each having a pre-negotiated fuel purchase account residing with the server 18.

The group 54 may have a group name corresponding to a pre-negotiated fuel purchase account number residing with the server 18. The group 54 may further have a membership fee 56 associated with sharing a predetermined amount of fuel at a fixed price for a predetermined period. The group 54 may be further associated with a pre-negotiated fuel purchase in a certain geographic area 58, such as, an area extending a predetermined distance from a predetermined fixed or varying point.

The group 54 may further include operations of one or more administrative members capable of restricting account actions made available to one or more other members of the group 54. In one example, the administrative user may restrict geographic area in which the one or more other members may acquire fuel using the pre-negotiated fuel purchase account. In another example, the administrative user may set a maximum amount of fuel or cost per transaction the one or more other members of the group 54 may authorize using the account. The application 40 is configured to receive input indicative of a group selection 60. The server 18 receives the group selection 60 and associates a user with a selected pre-negotiated fuel purchase group and the corresponding account number.

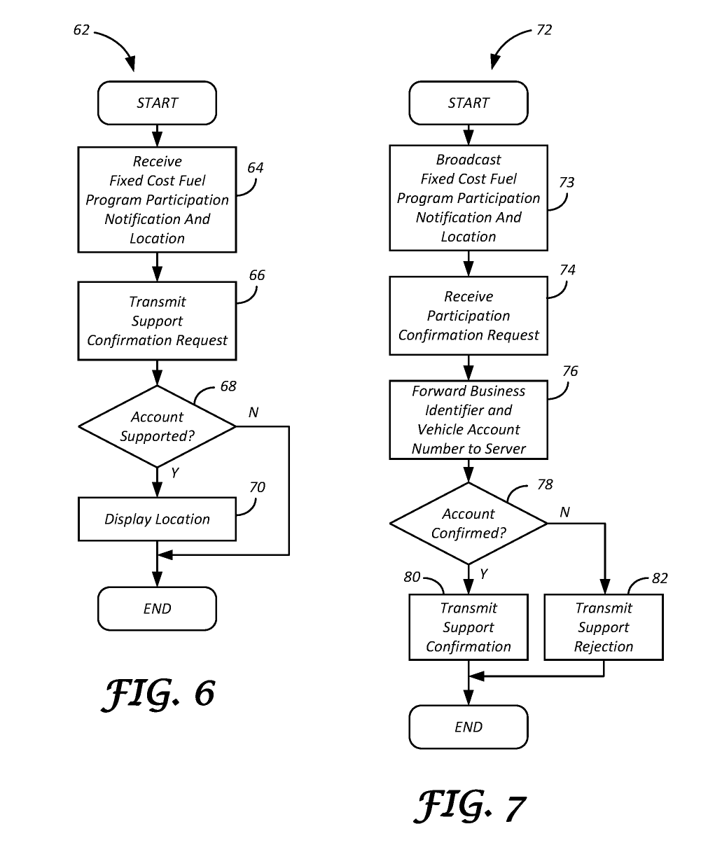

In reference to FIG. 6, a vehicle process 62 for receiving a DSRC broadcast indicative of the pre-negotiated fuel purchase program participation is shown. The vehicle process 62 may begin at block 64 where the controller 14 receives a notification, e.g., via a DSRC network infrastructure, from the business 16 indicative of a pre-negotiated fuel purchase program participation. The notification from the business 16 may further include a geographic location of the business 16. The controller 14 at block 66 transmits to the business 16 a signal indicative of a request to confirm participation. In one example, at block 66 the controller 14 may request a confirmation that a pre-negotiated fuel purchase account associated with the vehicle 12 is a participating account. The controller 14 request for a confirmation may include an account number of a pre-negotiated fuel purchase account associated with the vehicle 12.

At block 68 the controller 14 determines whether participation was confirmed. In one example, the controller 14 determines whether a confirmation was received from the business 16 indicative of a pre-negotiated fuel purchase account associated with the vehicle 12 being a participating account. The controller 14 at block 70 displays, e.g., via a visual front end interface, a location of the business 16 in response to determining at block 68 that a confirmation was received from the business 16 that a pre-negotiated fuel purchase account associated with the vehicle 12 is a participating account. The controller 14 exits the vehicle process 62 in response to determining at block 68 that a confirmation was not received from the business 16 that a pre-negotiated fuel purchase account associated with the vehicle 12 is a participating account, i.e., in response to receiving a rejection from the business 16. At this point the vehicle process 62 may end. In some embodiment the vehicle process 62 as described in reference to FIG. 6 may be repeated in response to receiving a notification indicative of a pre-negotiated fuel purchase program participation or in response to another notification or request.

In reference to FIG. 7, a business process 72 for confirming that a pre-negotiated fuel purchase account associated with the vehicle 12 is a participating account is shown. The business process 72 may begin at block 73 where the business 16 broadcasts a notification, e.g., via a DSRC network infrastructure, to the vehicle 12 indicative of a pre-negotiated fuel purchase program participation. The notification from the business 16 may further include a geographic location of the business 16.

At block 74 the business 16 receives a signal from the vehicle 12 indicative of a request to confirm that a pre-negotiated fuel purchase account associated with the vehicle 12 is a participating account. The business 16 at block 76 forwards to the server 18 a signal indicative of a request to confirm that a pre-negotiated fuel purchase account associated with the vehicle 12 is a participating account. In one example, the business 16 transmits to the server 18 an account number of a pre-negotiated fuel purchase account associated with the vehicle 12. The request forwarded by the business 16 may further include one or more identifiers associated with the business 16, such as, but not limited to, business geographic location, business type, name, brand, and so on.

At block 78 the business 16 determines whether a pre-negotiated fuel purchase account associated with the vehicle 12 was confirmed by the server 18. The business 16 at block 80 transmits to the vehicle 12 a notification indicative of a pre-negotiated fuel purchase account associated with the vehicle 12 being a participating account in response to determining at block 78 that a pre-negotiated fuel purchase account associated with the vehicle 12 was confirmed by the server 18.

The business 16 at block 82 transmits to the vehicle 12 a rejection indicative of a pre-negotiated fuel purchase account associated with the vehicle 12 not being a participating account in response to determining at block 78 that a pre-negotiated fuel purchase account associated with the vehicle 12 was not confirmed by the server 18. In one example, the server 18 may determine that an account associated with the vehicle 12 is not a participating account if the business 16 is located outside geographic area associated with the account. In another example, the server 18 may determine that an account associated with the vehicle 12 is not a participating account if at least one identifiers associated with the business 16 matches administrative user restrictions associated with the account.

At this point the business process 72 may end. In some embodiment the business process 72 as described in reference to FIG. 7 may be repeated in response to receiving a request to confirm that a pre-negotiated fuel purchase account associated with a vehicle is a participating account or in response to another notification or request. In some embodiments, at least blocks 74-82 of the business process 72 may be in response to a signal from the vehicle 12 indicative of a request for a participation confirmation as described in reference to at least blocks 66-68 of FIG. 6.

The processes, methods, or algorithms disclosed herein may be deliverable to or implemented by a processing device, controller, or computer, which may include any existing programmable electronic control unit or dedicated electronic control unit. Similarly, the processes, methods, or algorithms may be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms may also be implemented in a software executable object. Alternatively, the processes, methods, or algorithms may be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A system for a vehicle comprising:
a controller programmed to,
in response to receiving from a business a confirmation generated responsive to a forwarded verification request that an account associated with the vehicle is supported by a pre-negotiated fuel purchase program in which the business participates, display a location of the business and
in response to a disaffirmation generated responsive to the request, prevent the displaying.

2. The system of claim 1, wherein the account defines an advance purchase of fuel comprising gasoline, ethanol, hydrogen, or electricity to be received from participating businesses over a pre-negotiated time period within a limited geographic area.

3. The system of claim 2, wherein the account is hosted by a server and defines a plurality of members and vehicles authorized to receive the pre-purchased fuel over the pre-negotiated time period.

4. The system of claim 1, wherein the confirmation and the disaffirmation are generated by a server hosting pre-negotiated elements of the account responsive to the location of the business with respect to a pre-negotiated geographic area element.

5. The system of claim 1, wherein the disaffirmation is generated responsive to a server identifying a match between a business identifier included with the forwarded verification request and an administrative user restriction associated with the account.

6. The system of claim 5, wherein the restriction defines a business name, rating, a type of fuel sold, or a grade of fuel sold.

7. A method for a vehicle comprising:
in response to receiving by a controller via a dedicated short range network a broadcast indicative of a business being a fuel purchase program participant and a confirmation generated responsive to a forwarded verification request that an account associated with the vehicle is supported by the program, displaying a location of the business, and
in response to receiving a disaffirmation generated responsive to the forwarded verification request, preventing the displaying.

8. The method of claim 7, wherein the account defines an advance purchase of fuel comprising gasoline, ethanol, hydrogen, or electricity to be received from participating businesses over a pre-negotiated time period within a limited geographic area.

9. The method of claim 8, wherein the account is server-based and defines a plurality of members and vehicles authorized to receive the pre-purchased fuel over the pre-negotiated time period.

10. The method of claim 7, wherein the confirmation and the disaffirmation are generated responsive to the location of the business relative to a pre-negotiated geographic area.

11. The method of claim 7, wherein the disaffirmation is generated responsive to identifying a match between a business identifier included with the forwarded verification request and at least one administrative user-specified restriction associated with the account.

12. The method of claim 11, wherein the restriction defines a business name, rating, a type of fuel sold, or a grade of fuel sold.

13. A pre-purchased fuel program participation system for a business comprising:
a controller programmed to,
in response to a confirmation generated by a server responsive to a verification request received from a vehicle and forwarded to the server, the confirmation indicative of an account associated with the vehicle being supported by a pre-purchased fuel program of which the business is a previously-acknowledged participant, transmit a location of the business to be displayed in the vehicle, and
in response to a disaffirmation generated responsive to the verification request, prevent the transmitting of the location.

14. The system of claim 13, wherein the account defines an advance purchase of fuel comprising gasoline, ethanol, hydrogen, or electricity to be received from participating businesses over a pre-negotiated time period within a limited geographic area.

15. The system of claim 14, wherein one or more elements associated with the account are user-defined via a digital interface and reside with the server, the elements comprising a plurality of members and vehicles authorized to receive the pre-purchased fuel over the pre-negotiated time period.

16. The system of claim 13, wherein one of the confirmation and the disaffirmation are generated responsive to a relative position of the location of the business specified in the forwarded verification request and a pre-negotiated geographic area associated with the account.

17. The system of claim 13, wherein the disaffirmation is generated further responsive to identifying a match between a business identifier included with the forwarded verification request and at least one administrative user-specified restriction associated with the account.

18. The system of claim 17, wherein the restriction defines a business name, rating, a type of fuel sold, or a grade of fuel sold.
